(19) United States
(12) Patent Application Publication
(10) Pub. No.: US 2001/0010331 A1
(43) Pub. Date: Aug. 2, 2001

(54) Process for protecting a security module, and associated security module

(76) Inventor: Michel Hazard, Mareil/Mauldre (FR)

Correspondence Address: Edward J. Kondracki, Miles & Stockbridge P.C., Suite 500, 1751 Pinnacle Drive, McLean, VA, 22102, US

(21) Appl. No.: 09/794,038

(22) Filed: Feb. 28, 2001

Related U.S. Application Data
(63) Continuation of application No. 09/125,616, filed on Aug. 21, 1998, now abandoned.
Application No. 09/125,616 is a 371 of international application No. PCT/FR97/02389, filed on Dec. 23, 1997.

(30) Foreign Application Priority Data
Dec. 31, 1996 (FR) FR 96 16257

(51) Int. Cl. G06K 5/00

(52) U.S. Cl. 235/380

(57) ABSTRACT

The invention relates to a process for protecting a security module (8) designed to cooperate with a data processing device (1), the module being designed to execute a set of operations including at least one sensitive operation (23).

According to the invention, the process includes the steps comprised of:

executing, at the time of each execution of the sensitive operation and upstream from the latter, a first supplementary sequence of operations (22) intended to activate signaling means, and downstream from said sensitive operation, a second supplementary sequence of operations (24) intended to deactivate said signaling means;

verifying, at the time of each execution of the sensitive operation and upstream from said first supplementary sequence of operations (22), whether the signaling means have been deactivated;

in the case where the signaling means are activated, inhibiting the execution of the sensitive operation.

The invention relates to a process for protecting a security module designed to cooperate with a data processing device, the module comprising data processing means and data storage means and being designed to execute a set of operations including at least one sensitive operation. The term “sensitive operation” means any operation whose execution has serious repercussions on:

security in general: particularly in regard to any operation intended to verify a person's authorization with respect to access to certain information, services, or functions;

the application involved in particular: particularly in regard to any operation intended to define or modify certain parameters characterizing the fundamental rights and obligations of a user with respect to this application (for example, for a banking application, an operation intended to update an account balance).

The term “security module” should be taken either in its classic sense, in which it designates a device in a communication or information network intended to be held by an institution supervising the network and to be stored so as to be protected by secret and fundamental parameters of the network such as cryptographic keys, or more simply, as designating a device allocated to various users of the network, enabling each of them to have access to it, which latter device is also capable of holding secret parameters. The security module could take the form of a portable object of the chip card type.

The object of the invention is to prevent any interruption of the sensitive operation in the process of being executed from occurring, or at least to control the number of interruptions that are capable of occurring. The invention relates particularly to fraudulent interruptions, but does not exclude accidental interruptions. The risk is that the operations intended to protect the execution of the set of operations will not be executed. For example, in the case of a program for testing a confidential code presented by a user, there is an operation for writing the result of the comparison, the purpose of which is to limit the number of attempts authorized. If the defrauder succeeds in stopping the program after the comparison but before the writing of its result, he can repeat the operation a large number of times, presenting a new confidential code, and may possibly benefit from observing the electrical signals present in the terminals of the security module, signals that are practically always affected by the nature of the calculation or the result. By storing a large number of such observations and performing a statistical analysis, the defrauder may succeed in identifying the user's correct confidential code.

According to the invention, this problem is solved by providing measures which enable the security module to verify whether or not the sensitive operation or the previous sensitive operations initiated have been executed in full, and if not, to inhibit the execution of the next sensitive operation.

More precisely, the process according to the invention includes the steps comprised of:

executing, at the time of each execution of the sensitive operation and upstream from the latter, a first supplementary sequence of operations intended to activate signaling means, and downstream from this sensitive operation, a second supplementary sequence of operations intended to deactivate these signaling means;

counting each interrupted attempt for which the sensitive operation has been initiated but not executed, so that the signaling means have been initially activated but not subsequently deactivated, in order to define a number of interrupted attempts detected N_{RS};

defining a number of interrupted attempts authorized N_{RSA};

comparing, at the time of each execution of the sensitive operation and upstream from the latter, this number of interrupted attempts detected N_{RS} to the number of interrupted attempts authorized N_{RSA}; and

in the case where this number of interrupted attempts detected N_{RS} is greater than the number of interrupted attempts authorized N_{RSA}, inhibiting the execution of the sensitive operation.

The invention also relates to a security module designed to implement this process.

Other details and advantages of the present invention will emerge from the following description of a preferred but non-limiting embodiment, in reference to the appended drawings in which:

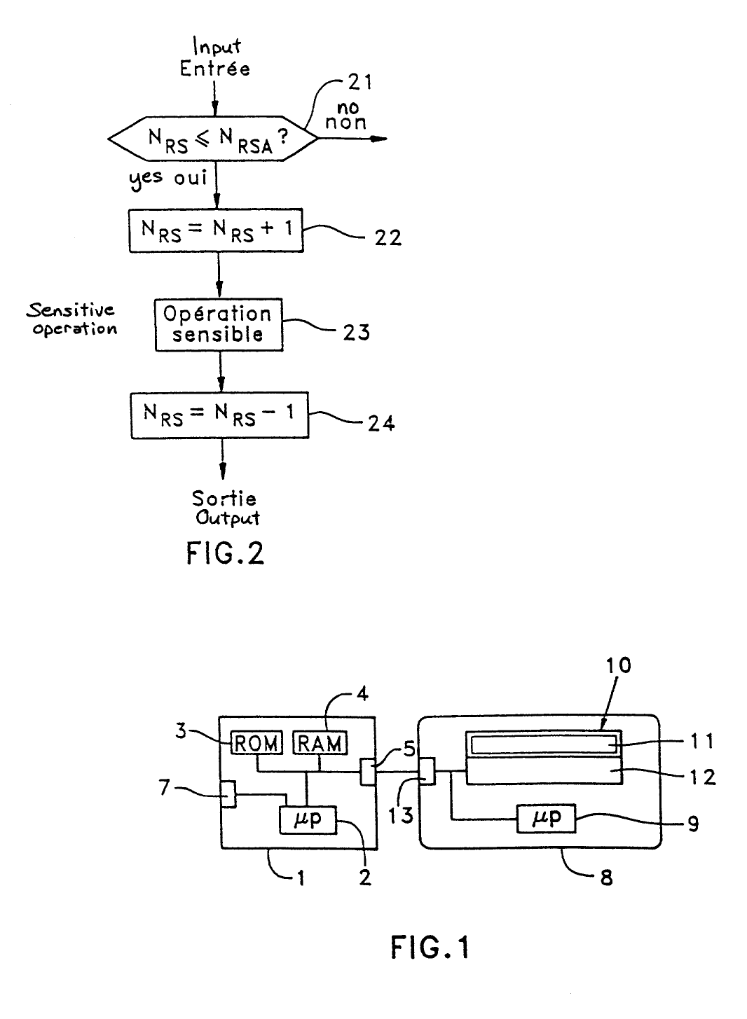

FIG. 1 is the diagram of a security module for which the invention is intended, which cooperates with a data processing device;

FIG. 2 is a flow chart of the execution of a sensitive operation; and

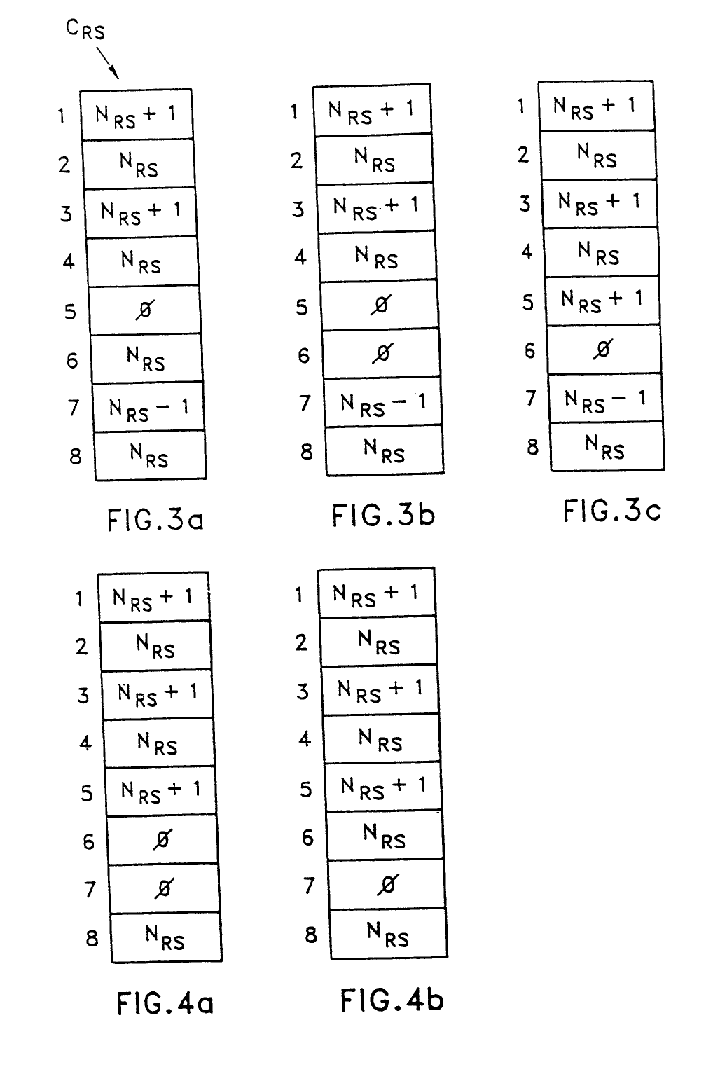

FIGS. 3a through 3c and 4a, 4b represent the state of a counter of sequence breaks C_{RS} at various instants during the execution of one or more sensitive operations.

The data processing device 1 represented in FIG. 1 comprises, in a known way, a microprocessor 2 to which are connected a ROM memory 3, a RAM memory 4, means 5 for cooperating with a security module 8, and a transmission interface 7 which allows the data processing device to communicate with another similar device, either directly or through a communications network.

The device 1 may or may not also be equipped with storage means such as diskettes or removable disks, data entry means (such as a keyboard and/or a pointing device of the mouse type) and display means, which various means are not represented in FIG. 1.

The data processing device can also be constituted by any data processing device installed at a private or public site and capable of providing means for managing information or supplying various goods or services, this device being permanently installed or portable. It can also be a telecommunications device. In addition, the security module 8 includes data processing means 9, an associated non-volatile memory 10, and means 13 for cooperating with the data processing device. This module is designed to define, in the memory 10, a secret area 11 in which information, once stored, is inaccessible from outside the module but accessible to the processing means 9, and a free area 12 which is accessible from outside the module for a reading and/or writing of information. Each memory area can comprise a non-erasable ROM part and a part that is an erasable EPROM, EEPROM or is constituted by a RAM memory of the “flash” type, that is, having the characteristics of an EEPROM memory, but with access times identical to those of a standard RAM. A volatile RAM memory, not represented, is also provided.

In particular, it is possible to use as the security module 8 a microprocessor with a non-volatile self-programmable memory like the one described in U.S. Pat. No. 4,382,279 in the name of the Applicant. As indicated on page 1, lines 5 through 17 of this patent, the self-programmable nature of the memory corresponds to the capability for a program fi located in this memory to change another program fj, also located in this memory, into a program gj. Although the means to be used to implement this self-programming can vary depending on the technology used to design the data processing means 9, it is noted that in the case where these processing means are constituted by a microprocessor associated with a non-volatile memory and according to the above-mentioned patent, these means can include:

data and address buffers, associated with the memory;

a program for writing in the memory, loaded into the latter and specifically containing the instructions that make it possible to maintain the programming voltage of the memory, as well as the data to be written and their addresses, for a sufficient length of time, which write program may possibly be replaced by a write controller with logic circuits.

In a variant, the microprocessor of the security module 8 is replaced—or at least supplemented—by logic circuits installed in a semiconductor chip. In effect, circuits of this type are capable of performing calculations, particularly for authentication and signature, because the electronics are hardwired, and not microprogrammed. In particular, they can be of the ASIC (Application Specific Integrated Circuit) type. Examples that may be cited are the SIEMENS component marketed under the reference number SLE 4436 and the SGS-THOMSON component marketed under the reference number ST 1335.

Advantageously, the security module 8 will be designed in monolithic form on a single chip.

In a variant of the microprocessor with a non-volatile self-programmable memory described above, the protected nature of the security module could result from its being located in an inviolable enclosure.

The signaling means mentioned above comprise at least one sequence break counter C_{RS} designed to count sequence breaks occurring during the execution of the sensitive operation, that is intervening in the step-by-step execution of this operation. This counter is incorporated into the data processing means 9 of the security module 8. According to the process of FIG. 2, two reference numbers are distinguished, namely a number of sequence breaks detected N_{RS} and a number of sequence breaks authorized N_{RSA}, the first of which corresponds to the number of sequence breaks that have occurred in the execution of a given sensitive operation since a predetermined instant, and the second of which corresponds to the maximum number of sequence breaks that can occur without disabling the security module. Typically, the instant from which the number of sequence breaks N_{RS} is calculated corresponds to a first use of the security module by a user for whom the latter is intended, the number N_{RS} accounting for any sequence break that has occurred from this instant up to a predetermined date. The number of sequence breaks authorized N_{RSA} is determined by an authority so as to account for sequence breaks resulting not only from a fraudulent act, but from faulty operations of the security module, which can occur spontaneously throughout its service life. Naturally, the N_{RSA} chosen must be small, otherwise a defrauder would have the benefit of a comfortable number of attempts to try to violate the security module. For example, N_{RSA} will be less than 20, and particularly less than 10.

At an input of the flow chart of the execution of the sensitive operation, a first step 21 is comprised of verifying whether the number of sequence breaks N_{RS} is in fact less than or equal to the number of authorized sequence breaks N_{RSA}. If not, it proceeds to a sequence break executed in order to inhibit the execution of the sensitive operation: this break can either be final in that it will prevent any subsequent execution of this sensitive operation, or possibly even disable any further functioning of the security module no matter what the intended operation, or temporary if it is anticipated that the sensitive operation can be re-executed in the future after a resetting of the number of sequence breaks N_{RS} by an authorized authority. On the other hand, if the number of sequence breaks N_{RS} is in fact less than or equal to the number of sequence breaks authorized N_{RSA}, a second step 22 is comprised of incrementing the sequence break counter C_{RS} by one unit. The next step is comprised of executing the sensitive operation itself. If this operation is executed in its entirety, that is, without the occurrence of any accidental or fraudulent sequence break, the sequence break counter C_{RS} is then decremented by one unit in step 24, in order to return to the value it had before the start of the sensitive operation.

In a variant, the operation 21 for testing the value of the number of sequence breaks N_{RS} can be executed after that 22 for incrementing the sequence break counter C_{RS} by one unit.

FIGS. 3a through 3c show successive states of the sequence break counter C_{RS}, upstream from the execution of a sensitive operation to be protected. This counter is constituted by a cyclic volume with a plurality of positions (at least three), each position being embodied by at least one storage cell. In this example, there are 8 positions, numbered 1 through 8. A value of the number of sequence breaks N_{RS} is stored in each position, except in one position (in this case the position 5), which is blank and does not contain any value. All blank positions are labelled by the symbol ø.

FIG. 3a represents the state of the counter upstream from the step 22 in the flow chart of FIG. 2. The position located above the blank position (in this case the position 4) stores a current value N_{RS} corresponding to an actual value of the counter, while the six positions 3 through 1, then 8 through 6, respectively, store different values, which increase successively with time, namely N_{RS}+1 for the position 3, N_{RS} for the position 2, etc., all the way to N_{RS}−2 for the oldest position 6, these positions corresponding to a certain number of successive sensitive operations.

It may be said that the positions 2 through 4 correspond to the following events:

position 2: state of the counter before step 22 of FIG. 2;

position 3: state of the counter just after step 22 (increase of one unit);

position 4: state of the counter just after the step 24 (decrease of one unit), which shows that no sequence break, either intentional or accidental, has occurred during this execution of the sensitive operation.

Furthermore, it may be said that the positions 7 and 8 correspond to the following events, relative to a prior execution of a sensitive operation:

position 7: state of the counter before step 22 of FIG. 2;

position 8: state of the counter just after step 22 (increase of one unit);

given that the next position 1 does not correspond to a decrease of one unit relative to the position 8 (that is N_{RS}−1), it must be concluded that a sequence break, either intentional or accidental, has in fact occurred during this execution of the sensitive operation, so the normally expected step 24 has not been executed. In conclusion, there has not been a new recording of a counter value since this value has not changed.

The position 6 corresponds to the state of the counter just before the step 24 during an even older execution of the sensitive operation. In effect, the value it contains corresponds to that of the position 7, increased by one unit.

Returning to the sensitive operation in the process of being executed, FIG. 3b shows the state of the sequence break counter in a preliminary phase of the execution of step 22 in the flow chart of FIG. 2. The data processing means 9 of the security module have proceeded to erase the position 6 located beneath the blank position 5, thus defining a new blank position. In FIG. 3c, the data processing means 9 have executed the step 22 of FIG. 2, adding one unit to the current value N_{RS} of the position 4 and storing the result N_{RS}+1 in the next position 5.

FIGS. 4a and 4b show successive states of the sequence break counter C_{RS}, downstream from the execution of the sensitive operation 23 of FIG. 2. FIG. 4A shows the state of the sequence break counter in a preliminary phase of execution of the step 24 of FIG. 2. The data processing means 9 of the security module have proceeded to an erasure of the position 7 located beneath the new blank position 6. In FIG. 4b, the data processing means 9 have executed the step 24 of FIG. 2, subtracting one unit from the current value N_{RS}+1 of the position 5 and storing the result N_{RS} in the next position 6.

It will be noted in the example of FIGS. 2 through 4b that the signaling function is advantageously interleaved with that for counting the sequence breaks by means of a single device: the sequence break counter C_{RS}.

Advantageously, the steps 21, 22 and 24 for incrementing and decrementing the counter could be designed as subprograms of a main program constituted by the sensitive operation itself. In this case, a label or address of the counter is introduced as a parameter when the sub-program is called. This mode of operation adds flexibility in the implementation of the sequences of operations.

In the case where it is sought to protect a plurality of distinct sensitive operations intended to be executed independently from one another, it is possible to define as many sequence break counters C_{RS} as there are operations, each verifying the proper execution of a given sensitive operation. However, in a preferred mode, only one common counter is defined, which will be incremented, and in principle decremented, during the execution of any of these sensitive operations. This observation is also true for the case where the counter is replaced by a flag.

An important concern of the invention is that the protection procedure described does not end up slowing or inhibiting the operation of the security module, by reason of the inevitable accidental interruptions observed throughout the latter's period of operation, relative not only to sensitive operations but also to ordinary operations, like those related to the application involved (financial application, performance of service, etc.) whose non-execution affects neither security in general, nor the fundamental rights and obligations of the user in the application in question. In effect, the large number of operations protected in this way would run the risk of consequently increasing the number of accidental interruptions observed: the number of sequence breaks authorized N_{RSA} would then be reached more quickly, so a partial or total disabling of the security module would also occur more quickly. This noteworthy result is obtained according to the invention by applying the security procedure described only to the operations that actually correspond to sensitive operations.

An improvement of the invention is comprised of the fact that the number of interrupted attempts authorized N_{RSA} includes a random number that varies each time a predetermined number of sensitive operations have been initiated. Thus, the number N_{RSA} varies with predetermined frequency, but it assumes successive values that are not predictable, which helps to interfere with any fraudulent observation of the behavior of the security module. This random number can advantageously be generated in the security module according to any of the software processes described in the U.S. Pat. Nos. 5,177,790 or 5,365,466. According to a variant, the number of interrupted attempts authorized N_{RSA} is composed of a fixed number to which a random number is added.

1. A process for protecting a security module (8) designed to cooperate with a data processing device (1), the module comprising data processing means (9, 2) and data storage means (10; 3, 4) and being designed to execute a set of operations including at least one sensitive operation (23), characterized in that it includes the steps comprised of:
executing, at the time of each execution of the sensitive operation and upstream from the latter, a first supplementary sequence of operations (22) intended to activate signaling means, and downstream from said sensitive operation, a second supplementary sequence of operations (24) intended to deactivate said signaling means;
counting each interrupted attempt for which the sensitive operation has been initiated but not executed, so that the signaling means have been initially activated but not subsequently deactivated, in order to define a number of interrupted attempts detected N_{RS};
defining a number of interrupted attempts authorized N_{RSA};
comparing, at the time of each execution of the sensitive operation and upstream from the latter, said number of interrupted attempts detected N_{RS} to said number of interrupted attempts authorized N_{RSA}; and
in the case where said number of interrupted attempts detected N_{RS} is greater than said number of interrupted attempts authorized N_{RSA}, inhibiting the execution of the sensitive operation.

2. The process according to claim 1 in which, in order to count each interrupted attempt, a counter is incremented by one unit at the time of each execution of the sensitive operation and upstream from the latter, and in the case where the sensitive operation has been executed, the counter is decremented by one unit downstream from the sensitive operation.

3. The process according to claim 1, in which said number of interrupted attempts authorized N_{RSA} includes a random number that varies each time the sensitive operation (33) has been initiated a predetermined number of times.

4. The process according to claim 1, in which the security module (8) is designed to execute a plurality of distinct sensitive operations (33) and each interrupted attempt related to any of these sensitive operations is counted by means of the same number of interrupted attempts detected N_{RS}.

5. A security module (8) designed to cooperate with a data processing device (1) and comprising data processing means (9, 2) and data storage means (10; 3, 4) and being designed to execute a set of operations including at least one sensitive operation (23), characterized in that it comprises:
signaling means designed to assume a state in which they are activated upstream from a sensitive operation to be protected, and another state in which they are deactivated downstream from the sensitive operation if the latter has been executed;
counting means for counting each interrupted attempt for which the sensitive operation has been initiated but not executed, so that the signaling means have been initially activated but not subsequently deactivated, in order to define a number of interrupted attempts detected N_{RS}, said data storage means (10; 3,4) storing a number of interrupted attempts authorized N_{RSA};
comparing means for comparing, at the time of each execution of the sensitive operation and upstream from the latter, said number of interrupted attempts detected N_{RS} to said number of interrupted attempts authorized N_{RSA}; and
inhibiting means for inhibiting, in the case where said number of interrupted attempts detected N_{RS} is greater than said number of interrupted attempts authorized N_{RSA}, the execution of the sensitive operation.

6. The security module according to claim 5, in which said signaling and counting means comprise a counter designed to be incremented by one unit at the time of each execution of the sensitive operation and upstream from the latter, and in the case where the sensitive operation has been executed, to be decremented by one unit downstream from the sensitive operation.
